(19) United States
(12) Patent Application Publication
(10) Pub. No.: US 2025/0002112 A1
(43) Pub. Date: Jan. 2, 2025

(54) MOTORCYCLE FRONT SUSPENSION ASSEMBLY

(71) Applicant: Flat Earth Motors, Inc., Schaumburg, IL (US)

(72) Inventor: Kirby Corkill, Schaumburg, IL (US)

(21) Appl. No.: 18/759,231

(22) Filed: Jun. 28, 2024

Related U.S. Application Data
(60) Provisional application No. 63/523,892, filed on Jun. 28, 2023.

(51) Int. Cl. B62K 25/04; B62K 21/00; B62K 25/00

(52) U.S. Cl. CPC B62K 25/04; B62K 21/00; B62K 25/005

(57) ABSTRACT

A suspension assembly for a motorcycle having a steering knuckle, a steering mount, an upper control arm, and a lower control arm. The steering knuckle defines an axle structurally configured to receive a wheel. The steering mount is coupled to the steering knuckle and has a first end and a second end, an offset portion of the first end defined as being offset relative to the steering knuckle. A steering arm is attachable to the first end of the steering mount. The upper and lower control arms are structurally configured for pivotable coupling to a frame, and pivotable coupled to the steering mount. The axle is positioned between the frame and the steering knuckle and positioned so as to define a rake and a trail, wherein the rake is substantially vertical and the trail is positive. A motorcycle is further disclosed.

### CROSS-REFERENCE TO RELATED APPLICATION

This application claims priority from U.S. Provisional Patent Application Ser. No. 63/523,892 filed on Jun. 28, 2023, entitled “MOTORCYCLE FRONT SUSPENSION ASSEMBLY”, the entire disclosure of which is hereby incorporated by reference in its entirety.

### BACKGROUND OF THE DISCLOSURE

### 1. Field of the Disclosure

The disclosure relates in general to motorcycles, and more particularly, to a motorcycle front suspension assembly.

### 2. Background Art

Motorcycles have been known in the art. A typical motorcycle comprises a two-wheeled vehicle powered by an internal combustion engine or an electric motor. The frame is designed to support the engine, fuel tank, and a seating arrangement. The front wheel is connected to the frame via a fork that enables steering, while the rear wheel is connected via a swingarm with a suspension system for improved ride comfort (or may be in a fixed configuration relative to the frame. Braking is achieved through hydraulic disc brakes or drum brakes, typically, on both wheels. Control mechanisms include a throttle, clutch, gear shift, and handlebar-mounted controls.

A number of different suspension systems have been defined and developed for motorcycles. Among these are a number of different front suspensions. There is a constant desire to improve handling characteristics of motorcycles, and one such vehicle is achieved through development of the front suspension system and the front steering system, that is, the front portion of the motorcycle.

Among other solutions are those that are disclosed in U.S. Pat. No. 4,638,881 issued to Morioka et al. and assigned to Honda Giken Kogyo Kabushiki Kaisha, as well as in PCT Pub. No. WO 2021/015954 A2 published to Mercier, and assigned to Bombardier Recreational Products Inc., and BRP US Inc. Each of the foregoing publications are incorporated by reference herein in their entireties.

### SUMMARY OF THE DISCLOSURE

The disclosure in an aspect is directed to a motorcycle comprising a frame, a suspension assembly, and a steering assembly. The frame has a stem tube. The suspension assembly has a steering knuckle, a steering mount, an upper control arm, a lower control arm and a suspension member. The steering knuckle defines an axle structurally configured to receive a wheel. The steering mount is coupled to the steering knuckle. The steering mount has a first end and a second end opposite the first end, an offset portion of the first end defined as being offset relative to the steering knuckle. The upper control arm has a first end pivotably coupled to the frame, and a second portion pivotably coupled to the first end of the steering mount. The lower control arm is spaced apart from the upper control arm. The lower control arm has a first end pivotably coupled to the frame and a second portion pivotable coupled to the second end of the steering mount. The suspension member extends between the frame and at least one of the upper control arm and the lower control arm between the frame and the steering knuckle. The axle is positioned between the frame and the steering knuckle.

The steering assembly comprises a stem, and a tie rod. The stem is rotatably positionable within the stem tube of the frame. The stem has an upper end and a lower end opposite the upper end, with a lower steering arm extending therefrom and positioned so that a distal end thereof is spaced apart from an axis defined by the stem within the stem tube. The tie rod is pivotably coupled at a first end to the distal end of the lower steering arm, and pivotably coupled to the offset portion of first end of the steering mount. A rake is defined and a trail is defined, wherein the rake is substantially vertical and the trail is positive.

In some configurations, the upper control arm and the lower control arm are substantially parallel with each other through an operating range of motion thereof.

In some configurations, the suspension member is mounted at a second end to the lower control arm.

In some configurations, the stem tube is oblique to the rake.

In some configurations, the motorcycle further includes a brake caliper coupled to the steering knuckle.

In some configurations, the axle is substantially perpendicular to the rake. Additionally, the axle extends to the opposite side of the lower control arm from the upper control arm, so as to be positionable between an outside riding surface and the lower control arm.

In some configurations, the first end of the lower control arm and the first end of the upper control arm are pivotable relative to the frame along an axis that is parallel to the axle.

In some configurations, the second end of the lower control arm and the second end of the upper control arm can pivot in multiple axis relative to the steering mount.

In some configurations, the tie rod can pivot relative to the distal end of the lower steering arm in multiple axis and the tie rod can pivot relative to the steering mount in multiple axis.

In some configurations, the motorcycle further includes handle bars coupled to the upper end of the stem, opposite the lower steering arm.

On some configurations, the rake is vertical.

In some configurations, the suspension member is a coil-over member.

In another aspect of the disclosure, the disclosure is directed to a suspension assembly for a motorcycle comprising a steering knuckle, a steering mount, an upper control arm, and a lower control arm. The steering knuckle defines an axle structurally configured to receive a wheel. The steering mount is coupled to the steering knuckle. The steering mount has a first end and a second end opposite the first end, an offset portion of the first end defined as being offset relative to the steering knuckle, with a steering arm attachable to the first end of the steering mount. The upper control arm has a first end structurally configured for pivotable coupling to a frame, and a second portion pivotably coupled to the first end of the steering mount. The lower control arm is spaced apart from the upper control arm. The lower control arm has a first end structurally configured for pivotable coupling to the frame and a second portion pivotable coupled to the second end of the steering mount. The axle is positioned between the frame and the steering knuckle and positioned so as to define a rake and a trail, wherein the rake is substantially vertical and the trail is positive.

In some configurations, the rake is substantially perpendicular to the axle.

In some configurations, when the upper and lower control arms are perpendicular to the steering mount, the axle extends below the lower control arm.

In some configurations, a distance between the rake at the contact with a ground and an axis taken perpendicular to the axle at the ground is between 1.5″ and 6″ when the lower control arm and the upper control arm are substantially parallel to the ground.

In some configurations, the suspension assembly further includes a suspension member having a first end coupled to one of the lower and the upper control arm, and a second end attachable to the frame.

In some configurations, the suspension member comprises a coil-over member wherein the first end is coupled to the lower control arm.

In yet another aspect of the disclosure, the disclosure is directed to a suspension assembly for a motorcycle comprising a steering knuckle and a steering mount. The steering knuckle defines an axle structurally configured to receive a wheel. The steering knuckle structurally configured to be pivotably attachable to a frame. The steering mount is coupled to the steering knuckle. The axle is positioned between the frame and the steering knuckle and positioned so as to define a rake and a trail, wherein the rake is substantially vertical and the trail is positive.

In some configurations, the suspension assembly further includes an upper control arm and a lower control arm. The upper control arm extends between the steering knuckle and structurally configured to be attached to the frame. The lower control arm extends between the steering knuckle and structurally configured to be attached to the frame.

### BRIEF DESCRIPTION OF THE DRAWINGS

The disclosure will now be described with reference to the drawings wherein:

FIG. 1 of the drawings is a side elevational view of a configuration of a motorcycle showing conventional front suspension;

FIG. 2 of the drawings is an inner perspective view of the front portion of the motorcycle of the present disclosure;

FIG. 3 of the drawings is an inner side elevational view of the front portion of the motorcycle of the present disclosure;

FIG. 4 of the drawings is an outer side elevational view of the front portion of the motorcycle of the present disclosure;

FIG. 5 of the drawings is a perspective cross-sectional view of the front portion of the motorcycle of the present disclosure;

FIG. 6 of the drawings is a cross-sectional view of the front portion of the motorcycle of the present disclosure; and

FIG. 7 of the drawings is an outer perspective view of the front portion of the motorcycle of the present disclosure.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

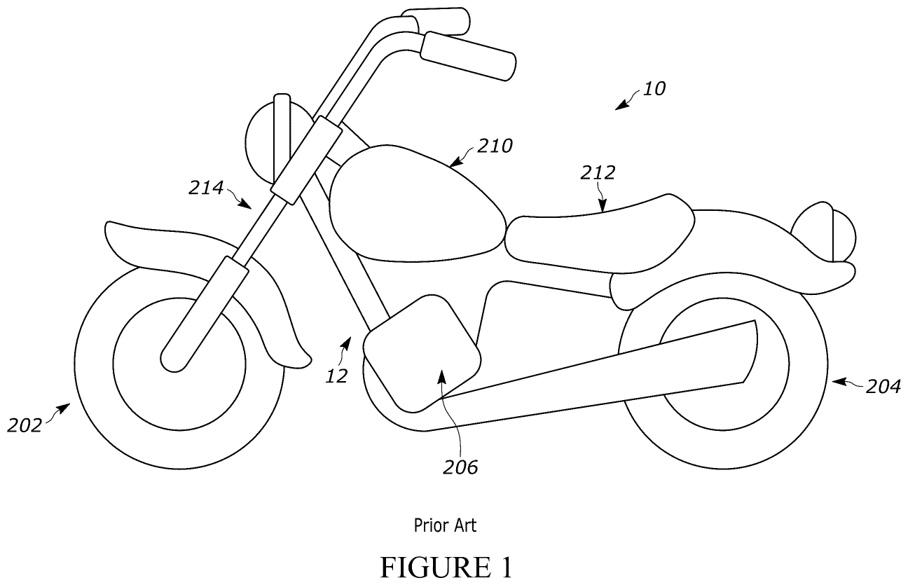

Referring now to the drawings and in particular to FIG. 1, a conventional motorcycle is shown at 10. As with most motorcycles suitable for modification with the suspension of the present disclosure, motorcycle 10 comprises a vehicle having two wheels, namely front wheel 202 and rear wheel 204, powered by an internal combustion engine or an electric motor 206. Frame 12 is designed to support the engine, fuel tank 210, and a seating arrangement 212. The front wheel 202 is connected to frame 12 via a fork 214 that enables steering, while the rear wheel 204 is connected via a swingarm with a suspension system for improved ride comfort (or may be in a fixed configuration relative to the frame 12. Braking is achieved through hydraulic disc brakes or drum brakes (not shown), typically, on both wheels. Control mechanisms include a throttle, clutch, gear shift, and handlebar-mounted controls (not shown).

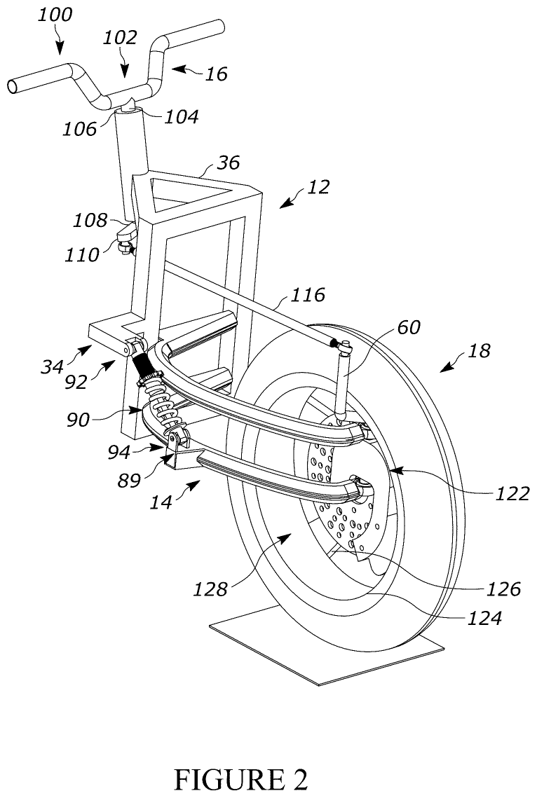

With reference to FIG. 2, a portion of a motorcycle (i.e., the front end thereof) is shown as comprising the frame 12, suspension assembly 14, steering assembly 16 and wheel assembly 18. It will be understood that the portion of the motorcycle shown can replace the front portion of a conventional motorcycle (including motorcycles that have multiple rear wheels), without limitation. One such motorcycle wherein the front portion can be replaced is the motorcycle shown in FIG. 1.

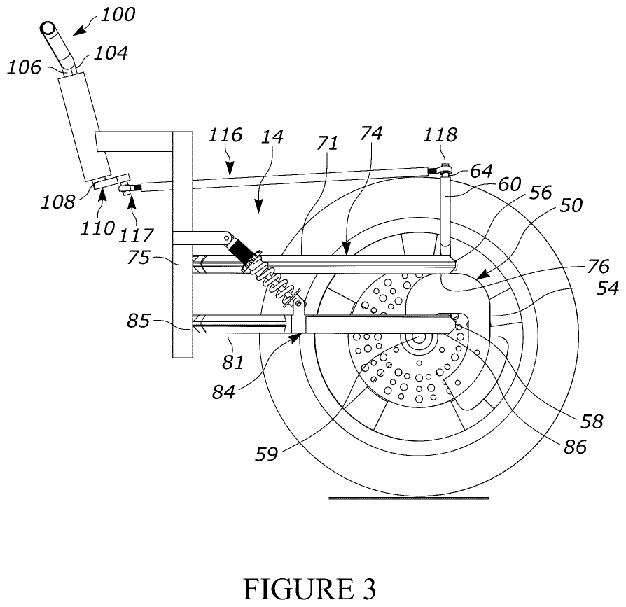

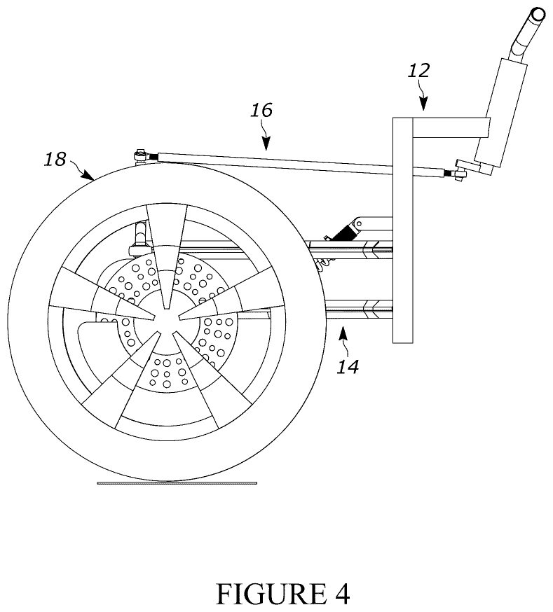

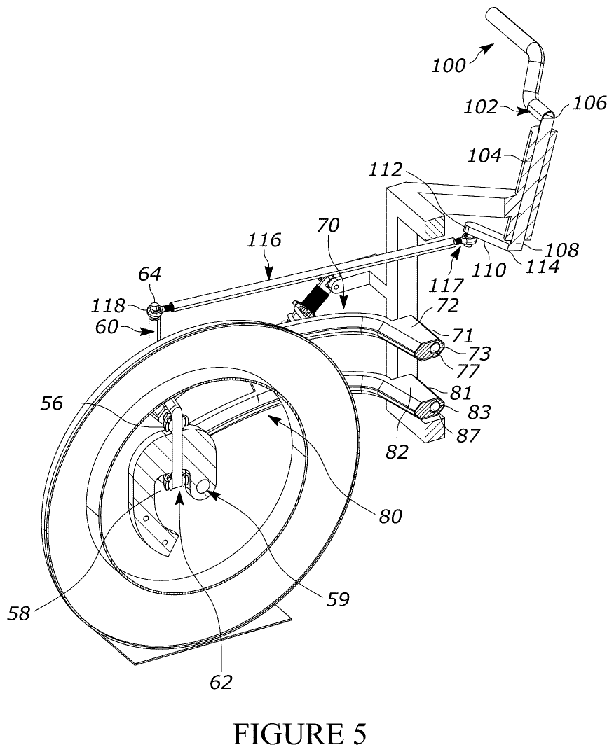

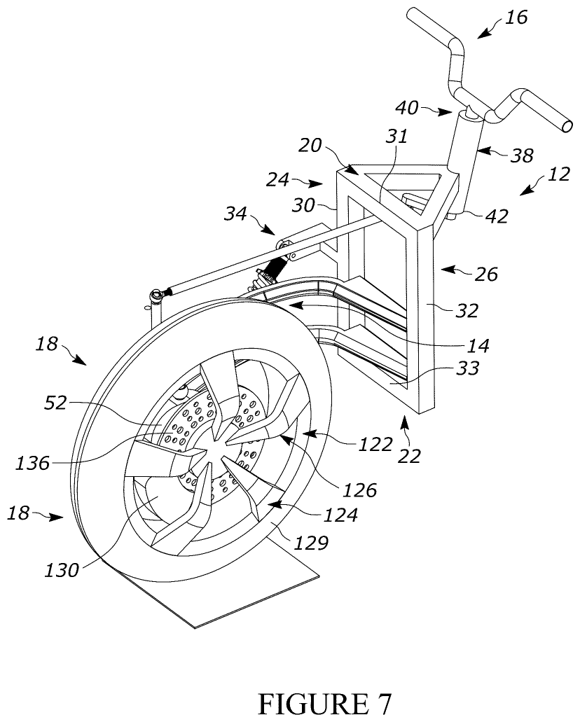

One configuration of the front portion of frame 12 is shown in FIGS. 2 through 7, collectively, as including top 20, bottom 22, front 24 and back 26. Frame 12 further includes first side support 30, second side support 32 spaced apart from first side support 30, and cross mounts 31 and 33. The components generally form a rectangular configuration. A suspension mount 34 extends from the first side support 30. A stem subframe 36 extends from the top 20 of the frame, and in the configuration shown, comprises a generally triangular structure wherein one of the sides is formed by cross mount 31. Of course, it will be understood that the configuration is exemplary and a number of different frame constructions are contemplated, and useful for creating the configuration set forth herein and the relationship between components.

A stem tube 38 is coupled to the stem subframe 36 opposite the cross mount 31 and generally extends in a vertical direction, inclined relative to the first and second side supports (and generally equally spaced apart from either. The stem tube generally extends above and below the stem subframe 36. The stem tube comprises an elongated tube having a bore extending therethrough and defines an upper end 40 and a lower end 42.

The suspension assembly 14 is shown as comprising steering knuckle 50, steering mount 60, upper control arm assembly 70, lower control arm assembly 80 and suspension member 90. The steering knuckle 50 includes outer side 52, inner side 54 opposite the outer side 52, upper control arm mount 56, lower control arm mount 58 and axle 59. A brake caliper 130 may be mounted to the steering knuckle 50.

It will be understood that a wheel assembly 18 is mounted to the steering knuckle, and may include a wheel hub mounted to the axle 59 to which brake disk 132 is coupled, and to which the wheel rim 122 is coupled. The wheel rim 122 includes a spoke portion 126 and an outer rim 124 which defines an inner cavity 128. A tire 129 can be mounted to the outer rim 124.

Referring again to the suspension assembly 14, steering mount 60 of the suspension assembly 14 includes a first end 62 and a second end 64. The first end is fixedly coupled to the steering knuckle (and extends therethrough, together forming the upper and lower control arm mounts 56, 58), with the second end 64 being spaced apart therefrom. In the configuration shown, the steering mount 60 includes a first component which extends through the steering knuckle, a second component that away from the steering knuckle in a direction out of the inner cavity 128 defined by the outer rim 124, and a third component that extends in an upward direction along the rim and the tire and terminates at the second end. Of course, other configurations are contemplated wherein the second end 64 is spaced apart from the steering knuckle and which can provide a moment arm relative thereto. Additionally, the first end of the steering mount extends from the steering knuckle in front of the axle 59 (i.e., such that the first end of the steering mount is on the opposite side of the axle relative to the frame 12). This defines a steering mount offset, which may be, for example, between 1.5″ and 6″.

The upper control arm assembly 70 is shown as including arm 71 and base pivot axle 77. The arm 71 includes base portion 72 which includes a pivot bore 73, and an extending portion which extends away from the base portion and is defined by first end 75 and second end 76. In the configuration shown, the base portion 72 is positionable between the first side support 30 and second side support 32, and can pivot about base pivot axle 77 which extends through the pivot bore 73. The extending portion extends between the base portion and the steering knuckle, following a generally concave configuration relative to the steering knuckle (so as to allow the wheel assembly to rotate during turning without a portion of the rim or the tire contacting the extending portion).

The second end 76 of the extending portion 74 is coupled to the upper control arm mount 56 of the steering knuckle 50 (which may comprise a ball joint, among other types of joints). It will be understood that due to the coupling at the base portion of the arm, the arm can pivot about the base pivot axle 77 in a direction that is generally perpendicular to the stem tube (and generally parallel to the axle when the wheel is positioned to be straight forward).

The lower control arm assembly 80 is substantially similar to the upper control arm 70. Like components will be described and have the same reference number augmented by 10 (i.e., reference number+10). The lower control arm 80 includes arm 81 and base pivot axle 87. The arm 81 includes base portion 82 which includes pivot bore 83, and an extending portion which extends away from the base portion and is defined by first end 85 and second end 86. In the configuration shown, the base portion is positionable between the first side support 30 and the second side support 32, between the upper control arm assembly and the cross mount 33. The base portion 82 can pivot about base pivot axle 87 which extends through the pivot bore 83. The extending portion extends between eh base portion and the steering knuckle following a generally concave configuration relative to the steering knuckle.

The second end 86 of the extending portion 84 is coupled to the lower control arm mount 58 of the steering knuckle 50, which also may comprise a ball joint. It will be understood that, as with the upper knuckle, the lower knuckle can pivot about the base pivot axle 87 in a direction that is generally perpendicular to the stem tube. Additionally, it will be understood that in the configuration shown, the spacing between the base portion 72 and the base portion 82 is substantially identical to the spacing between the upper control arm mount 56 and the lower control arm mount, such that at either end of the upper and lower control arms, the two are spaced apart the same distance, thereby remaining substantially parallel to each other through travel.

The lower control arm 80 further includes suspension mount 89 which is positioned on the extending portion between the first and second ends thereof. Suspension member 90 (which may comprise a coil over spring/damper structure) may have a first end 92 coupled to the suspension mount 34 of the frame and a second end 94 coupled to the suspension mount 89 of the lower control arm 80.

The steering assembly 16 is shown as comprising handle bars 100, stem 104, lower steering arm 110 and tie rod 116. The stem 104 includes an upper end 106 and a lower end 108. The upper end 106 is coupled to the handle bars 100 about a central region 102 thereof. The stem extends through the stem tube 38 of the frame 12. The lower steering arm 110 is coupled to the lower end 108 of the stem 104 at a proximal end 114 of the lower steering arm 110.

The tie rod 116 includes first end 117 and second end 118. The first end 117 is attached to the distal end 112 of the lower steering arm 110. The second end 118 of the tie rod 116 is attached to the second end 64 of the steering mount 60.

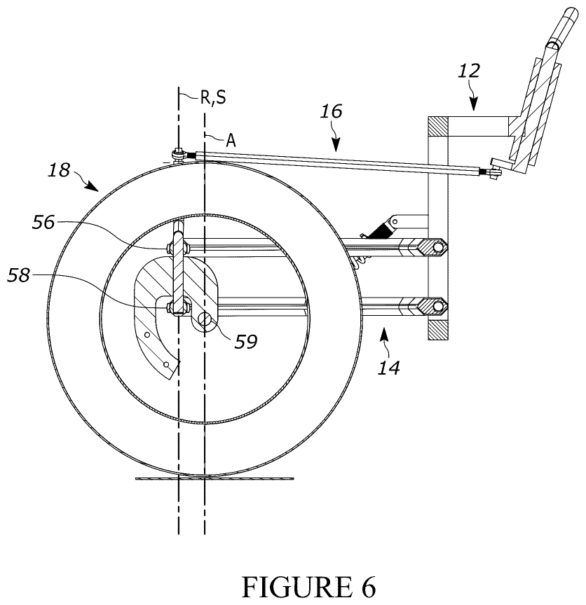

Referring now to FIG. 6, it will be understood that the rake is defined as the angle that the steering coupling is tilted back from vertical, that is, the axis R relative to a vertical axis. The trail is the distance, at the ground, between an axis S that is through the steering coupling and an axis A that is vertically through the axle. If the axis S at the ground is in front of the axis A, then the suspension has a positive rake.

In the present disclosure, the axis R extends through the steering coupling and is defined by an axis that extends through the upper control arm mount and the lower control arm mount. As can be seen that axis is substantially vertical (i.e., +/−2°). The trail is positive in that the axis S (which also corresponds to the axis R) is in front of the axis A and that distance is between 1.5″ and 6″ or less than 1.5″ or greater than 6″. Thus, the suspension has a vertical rake and a positive trail.

It will be understood that a number of variations are contemplated to the frame, and the suspension assembly, as long as the vertical rake and positive trail is maintained. Additionally, in such a configuration, advantageously, the suspension assembly approaches the wheel from a single side, thus, leaving the opposite side free from interference with suspension components.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A motorcycle comprising:
a frame having a stem tube;
a suspension assembly comprising:
a steering knuckle, the steering knuckle defining an axle structurally configured to receive a wheel;
a steering mount coupled to the steering knuckle, the steering mount having a first end and a second end opposite the first end, an offset portion of the first end defined as being offset relative to the steering knuckle;
an upper control arm having a first end pivotably coupled to the frame, and a second portion pivotably coupled to the first end of the steering mount;
a lower control arm spaced apart from the upper control arm, the lower control arm having a first end pivotably coupled to the frame and a second portion pivotable coupled to the second end of the steering mount; and
a suspension member extending between the frame and at least one of the upper control arm and the lower control arm between the frame and the steering knuckle;
wherein the axle is positioned between the frame and the steering knuckle; and
a steering assembly comprising:
a stem rotatably positionable within the stem tube of the frame, the stem having an upper end and a lower end opposite the upper end, with a lower steering arm extending therefrom and positioned so that a distal end thereof is spaced apart from an axis defined by the stem within the stem tube; and
a tie rod pivotably coupled at a first end to the distal end of the lower steering arm, and pivotably coupled to the offset portion of first end of the steering mount;
wherein a rake is defined and a trail is defined, wherein the rake is substantially vertical and the trail is positive.

2. The motorcycle of claim 1 wherein the upper control arm and the lower control arm are substantially parallel with each other through an operating range of motion thereof.

3. The motorcycle of claim 1 wherein the suspension member is mounted at a second end to the lower control arm.

4. The motorcycle of claim 1 wherein the stem tube is oblique to the rake.

5. The motorcycle of claim 1 further including a brake caliper coupled to the steering knuckle.

6. The motorcycle of claim 1 wherein the axle is substantially perpendicular to the rake, and wherein the axle extends to an opposite side of the lower control arm from the upper control arm, so as to be positionable between an outside riding surface and the lower control arm.

7. The motorcycle of claim 1 wherein the first end of the lower control arm and the first end of the upper control arm are pivotable relative to the frame along an axis that is parallel to the axle.

8. The motorcycle of claim 1 wherein the second end of the lower control arm and the second end of the upper control arm can pivot in multiple axis relative to the steering mount.

9. The motorcycle of claim 1 wherein the tie rod can pivot relative to the distal end of the lower steering arm in multiple axis and the tie rod can pivot relative to the steering mount in multiple axis.

10. The motorcycle of claim 1 further comprising handle bars coupled to the upper end of the stem, opposite the lower steering arm.

11. The motorcycle of claim 1 wherein the rake is vertical.

12. The motorcycle of claim 1 wherein the suspension member is a coil-over member.

13. A suspension assembly for a motorcycle:
a steering knuckle, the steering knuckle defining an axle structurally configured to receive a wheel;
a steering mount coupled to the steering knuckle, the steering mount having a first end and a second end opposite the first end, an offset portion of the first end defined as being offset relative to the steering knuckle, with a steering arm attachable to the first end of the steering mount;
an upper control arm having a first end structurally configured for pivotable coupling to a frame, and a second portion pivotably coupled to the first end of the steering mount;
a lower control arm spaced apart from the upper control arm, the lower control arm having a first end structurally configured for pivotable coupling to the frame and a second portion pivotable coupled to the second end of the steering mount; and
wherein the axle is positioned between the frame and the steering knuckle and positioned so as to define a rake and a trail, wherein the rake is substantially vertical and the trail is positive.

14. The suspension assembly of claim 13 wherein the rake is substantially perpendicular to the axle.

15. The suspension assembly of claim 13 wherein when the upper and lower control arms are perpendicular to the steering mount, the axle extends below the lower control arm.

16. The suspension assembly of claim 1 wherein a distance between the rake at a contact with a ground and an axis taken perpendicular to the axle at the ground is between 1.5″ and 6″ when the lower control arm and the upper control arm are substantially parallel to the ground.

17. The suspension assembly of claim 13 further including a suspension member having a first end coupled to one of the lower and the upper control arm, and a second end attachable to the frame.

18. The suspension assembly of claim 17 wherein the suspension member comprises a coil-over member wherein the first end is coupled to the lower control arm.

19. A suspension assembly for a motorcycle:
a steering knuckle, the steering knuckle defining an axle structurally configured to receive a wheel, the steering knuckle structurally configured to be pivotably attachable to a frame; and
a steering mount coupled to the steering knuckle;
wherein the axle is positioned between the frame and the steering knuckle and positioned so as to define a rake and a trail, wherein the rake is substantially vertical and the trail is positive.

20. The suspension assembly of claim 19 further comprising:
an upper control arm extending between the steering knuckle and structurally configured to be attached to the frame; and
a lower control arm extending between the steering knuckle and structurally configured to be attached to the frame.
